(19) United States
(12) Patent Application Publication
(10) Pub. No.: US 2006/0066715 A1
(43) Pub. Date: Mar. 30, 2006

(54) Image forming apparatus

(75) Inventor: Takashi Fukui, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/235,189

(22) Filed: Sep. 27, 2005

(30) Foreign Application Priority Data
Sep. 29, 2004 (JP) 2004-284638

(51) Int. Cl. B41J 2/435

(52) U.S. Cl. 347/262

(57) ABSTRACT

An image-forming apparatus for forming an image on a long flexible recording medium carried continuously in a specified transportation direction, including: at least two rollers over which the long flexible recording medium is stretched; a tension setting portion for stretching the long flexible recording medium horizontally by keeping the tension of a portion extending between the two adjacent rollers constant; and an image-forming unit for forming a two-dimensional pattern on the long flexible recording medium stretched between the two adjacent rollers horizontally.

### CROSS-REFERENCE TO RELATED APPLICATION

This application claims priority under 35 USC 119 from Japanese Patent Application No. 2004-284638, the disclosure of which is incorporated by reference herein.

### BACKGROUND OF THE INVENTION

1. Field of the Invention

The present invention relates to an image-forming apparatus for forming images onto the long flexible recording medium.

2. Description of the Related Art

As generally used image-forming apparatuses, a scanning type printed board exposing apparatus which forms a desired image on a recording medium by scanning the recording medium with a light beam, a laser photo plotter, a laser printer and the like are available.

In such an exposing apparatus, for example, in the printed board exposing unit, an image is formed by scanning a board material for a printed wiring board serving as a recording medium with a laser beam. As the material for the printed wiring board, a conductive thin film is formed on an insulation layer and the conductive thin film is covered with a photo resist.

The printed board exposing unit scans such a material with laser beam modulated based on image data to make the photo resist layer photosensitive in a desired board pattern.

The material for a printed wiring board that has undergone the exposure processing is removed from the printed board exposing unit and subjected to photo etching processing to complete a printed board.

In a conventional printed board exposing unit as used above, a long belt-like recording medium is stretched between a loader for sending out a roll sheet-like recording medium and an unloader for collecting this recording medium. With a portion of this stretched recording medium placed and fixed on an image forming surface of an image forming table, this image forming table is slidable at a high precison by a sliding means. A scanning type optical system for scanning with a laser beam is disposed just above the recording medium stretched between the loader and the unloader.

While the image forming table in which the stretched portion of the recording medium is fixed on an image forming surface by a fixing means is carried at a high precision by the sliding means, the optical scanning system scans the medium sliding with the image forming table precisely with laser beam modulated based on image data to form an image.

In this conventional printed board exposing unit, to restart image forming processing after first image forming processing terminates, the fixing means of the image forming table is released and the recording medium is fixed with a pair of clamp rollers of the loader and with a pair of drive rollers of the unloader. Then, the image forming table is moved to the side of the loader by the sliding means. Next, the recording medium is fixed on the image forming surface of the image forming table by the fixing means of the image forming table. Next, the pair of the clamp rollers of the loader is released and the recording medium is fed out with a pair of feeding rollers of the loader to form slack. Then, the image forming table is moved to the side of the unloader by the sliding means and the recording medium fixed on the image forming surface of the image forming table is scanned with the scanning optical system. The recording medium is collected within the unloader by the pair of the drive rollers of the unloader, and the image forming processing is terminated. If a next image forming processing is executed, the above-described operation is repeated necessary number of times (see, for example, Japanese Patent Application Laid-Open (JP-A) No. 2000-235267).

In such a conventional printed board exposing unit, by the before time when a next image forming processing is started after an image forming processing terminates, the fixing means of the image forming table is released, the recording medium is fixed at the loader and the unloader, the image forming table is moved to the side of the loader by the sliding means, the recording medium is fixed on the image forming surface of the image forming table by the fixing means of the image forming table, the clamp roller pair of the loader is released and an operation for forming slack by feeding the recording medium with the feeding roller of the loader is completed. Until these operations are completed, the conventional printed board exposing unit cannot proceed to a next drawing operation. Thus, waiting time separate from the time during which exposure processing is carried out may increase.

### SUMMARY OF THE INVENTION

According to a first aspect of the present invention, there is provided an image-forming apparatus for forming an image on a long flexible recording medium carried continuously in a specified transportation direction, comprising: at least two rollers over which the long flexible recording medium is stretched; a tension setting portion for stretching the long flexible recording medium horizontally by keeping the tension of a portion extending between the two adjacent rollers constant; and an image-forming unit for forming a two-dimensional pattern on the long flexible recording medium stretched between the two adjacent rollers horizontally.

With the above-described structure, the long flexible recording medium is stretched between two rollers, and it is carried in a state in which it is stretched horizontally by keeping the tension of a portion extending between the two rollers constant by the tension setting means. Then, the image forming processing can be executed continuously in a two-dimensional pattern with the image-forming unit on the portion stretched between the two rollers and tensed horizontally by keeping the tension constant. Thus, because the exposure processing can be continued without interruption, the waiting time is reduced and the exposure processing is executed in a short time, thereby improving productivity.

According to a second aspect of the present invention, in the image-forming apparatus of the first aspect, a lower supporting portion for maintaining the flatness of the flexible recording medium is disposed at the back side of the long flexible recording medium stretched horizontally between the two adjacent rollers to form an image with the image-forming unit.

According to a third aspect of the present invention, in the image-forming apparatus of the second aspect, the lower supporting portion is a flat sliding guide member.

With the above-described structure, in addition to the operation and effect of the first aspect of the invention, the long flexible recording medium stretched horizontally between the two adjacent rollers is supported by the lower supporting means from the back to maintain the flatness of the flexible recording medium. As a consequence, the image forming processing can be executed in a state in which higher flatness is maintained, thereby further improving the stability of the image forming processing.

According to a fourth aspect of the present invention, the image-forming apparatus of one of the first through third aspects further comprises an alignment unit, the alignment unit being provided on the side of a surface, on which the image is formed, or a surface, on which the image is not formed, of the flexible recording medium at a position at an upstream side of the image-forming unit in the transportation direction with respect to the long flexible recording medium stretched horizontally between the two adjacent rollers.

With the above-described structure, in addition to the operation and effect of the first to third aspects of the invention, the freedom of design of the image-forming apparatus is expanded and compactness is achieved.

According to a fifth aspect of the present invention, the image-forming apparatus of one of first through third aspects comprises plural image-forming units, the image-forming units being provided on both surface sides of the long flexible recording medium stretched horizontally between the two adjacent rollers.

With the above-described structure, in addition to the operation and effect of the first to third aspect of the invention, the front and rear surfaces of the long flexible recording medium can be subjected to image formation at the same time, thereby improving the efficiency of the image forming processing.

According to a sixth aspect of the present invention, the image-forming apparatus of the fifth aspect further comprises an alignment unit, the alignment unit being provided at the upstream side of at least one of the image-forming units provided on both surface sides of the long flexible recording medium stretched horizontally between the two adjacent rollers.

According to a seventh aspect of the present invention, the image-forming apparatus of the fifth aspect further comprises plural alignment units, the alignment units being provided at the upstream side of the image-forming units provided on both surface sides of the long flexible recording medium stretched horizontally between the two adjacent rollers.

According to an eighth aspect of the present invention, in the image-forming apparatus of the first aspect, the image-forming unit comprises a laser exposure device.

According to a ninth aspect of the present invention, in the image-forming apparatus of the fist aspect, the image-forming unit modulates a light beam with a spatial optical modulation device to execute exposure processing in a two-dimensional pattern.

According to a tenth aspect of the present invention, in the image-forming apparatus of the first aspect, after the image-forming unit modulates a light beam with a spatial optical (light) modulation device, the beam is focused on the long flexible recording medium by means of an auto focus mechanism to project the two-dimensional pattern.

With the above-described structure, even if there is some variation in distance between the image-forming unit and the long flexible recording medium stretched between the two adjacent rollers, the exposure processing can be executed appropriately by focusing a two-dimensional pattern with an auto focus mechanism thereby improving the exposure quality.

### BRIEF DESCRIPTION OF THE DRAWINGS

FIG. 1 is a perspective view showing a schematic structure of the main portions of an image-forming apparatus according to an embodiment of the present invention.

FIG. 2 is a front view showing a schematic structure of the main portions of the image-forming apparatus according to the embodiment of the invention.

FIG. 3 is a structural view showing a state in which a scanning carrying portion having a detection unit of the image-forming apparatus according to the embodiment of the invention is moved to a position for calibration of an alignment camera.

FIG. 4 is a structural view showing a state in which the scanning carrying portion having the detection unit of the image-forming apparatus according to the embodiment of the invention is moved to a position for detection of a beam position.

FIG. 5 is a structural view showing a state in which the scanning carrying portion having the detection unit of the image-forming apparatus according to the embodiment of the invention is moved to a position for calibration of exposure power.

FIG. 6 is a structural view showing an example in which a guide for the flexible printed wiring board material is provided on a carrying path of an exposure processing portion in the image-forming apparatus of the embodiment of the invention.

FIG. 7 is a structural view showing an example in which an alignment unit is provided on a side opposite from the head assembly on the carrying path of the exposure processing portion in the image-forming apparatus of the embodiment of the invention.

FIG. 8 is a structural view showing an example in which an alignment unit and a head assembly of an exposure head unit are provided on both upper and lower surface sides of the carrying path of the exposure processing portion in the image-forming apparatus according to the embodiment of the invention.

FIG. 9 is a plan view of major portions exemplifying a flexible printed wiring board material to undergo exposure processing by the image-forming apparatus according to the embodiment of the invention.

### DETAILED DESCRIPTION OF THE INVENTION

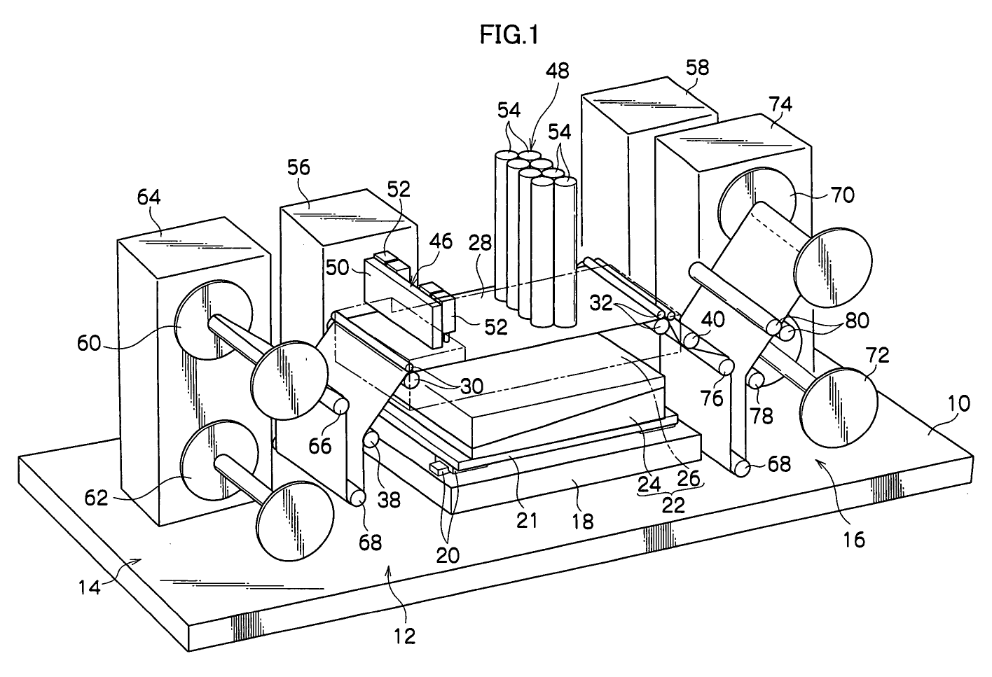

Preferred embodiments of the image-forming apparatus of the present invention will be described with reference to FIGS. 1 to 9.

The image-forming apparatus of the embodiment of the invention is automatically controlled by a control unit, and while a flexible printed wiring board material, which is a flexible recording medium formed as a long belt-like sheet, is moved in the direction of main scanning, an exposing head spatially modulates a multi-beam emitted from a light source side based on a modulation signal generated from image data by the control unit and projects the multi-beam onto the flexible printed wiring board so as to perform exposure processing.

In this image-forming apparatus, as shown in FIG. 1, an exposure processing portion 12 is disposed in the central portion of a floor base 10, an unexposed recording medium supply portion 14 is disposed on one side portion (left portion in FIG. 1) of this exposure processing portion 12, and an exposed recording medium collecting portion 16 is disposed on the other side portion (right portion in FIG. 1) of the exposure processing portion 12.

In this exposure processing portion 12, a board carrying portion 22 is mounted on a flat surface of an apparatus base 18 having an anti-vibration function provided on the floor base 10.

This linear moving mechanism 20 is constructed by mounting a linear motor or other carrying means between the top flat portion of the apparatus base 18 having an anti-vibration function and a moving table 21 provided with a board carrying portion 22.

If this linear moving mechanism 20 is constructed of, for example, a linear motor, a bar-like stator portion (magnet portion) 20A is provided on the apparatus base 18 having an anti-vibration function along the carrying direction, and a coil portion 20B is provided on the bottom face of the moving table 21. Due to this linear motor, the moving table 21 is moved in the carrying direction by a drive force generated by magnetic field generated by electrification of the coil portion 20B and a magnetic field of the stator portion 20A.

In this linear motor, constant speed and positioning accuracy in carrying operation of the board carrying portion 22, torque deflection at the time of startup or stopping and the like, can be controlled at a high precision under electric control.

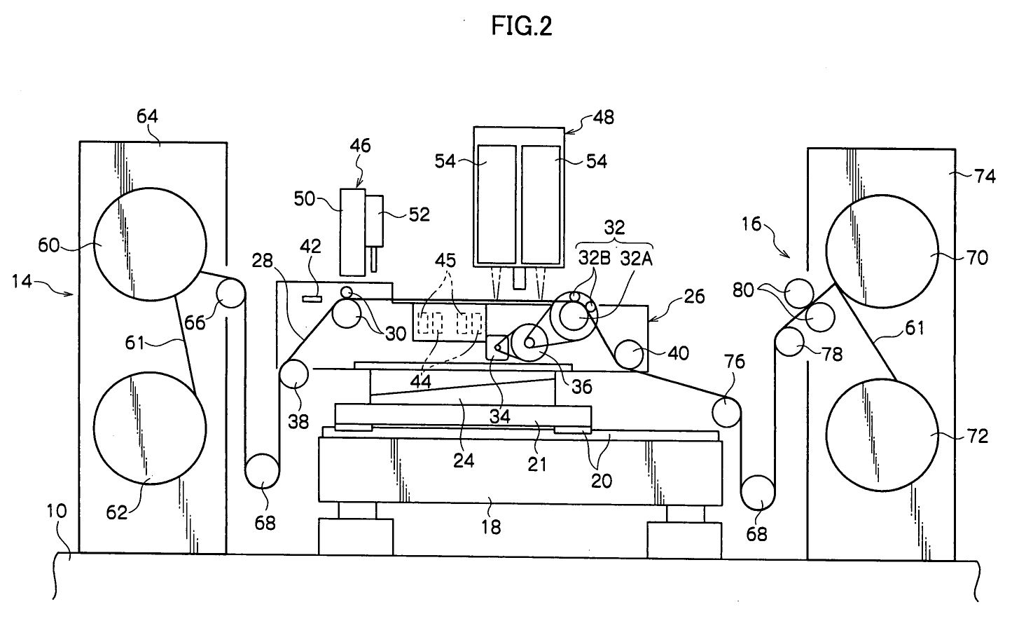

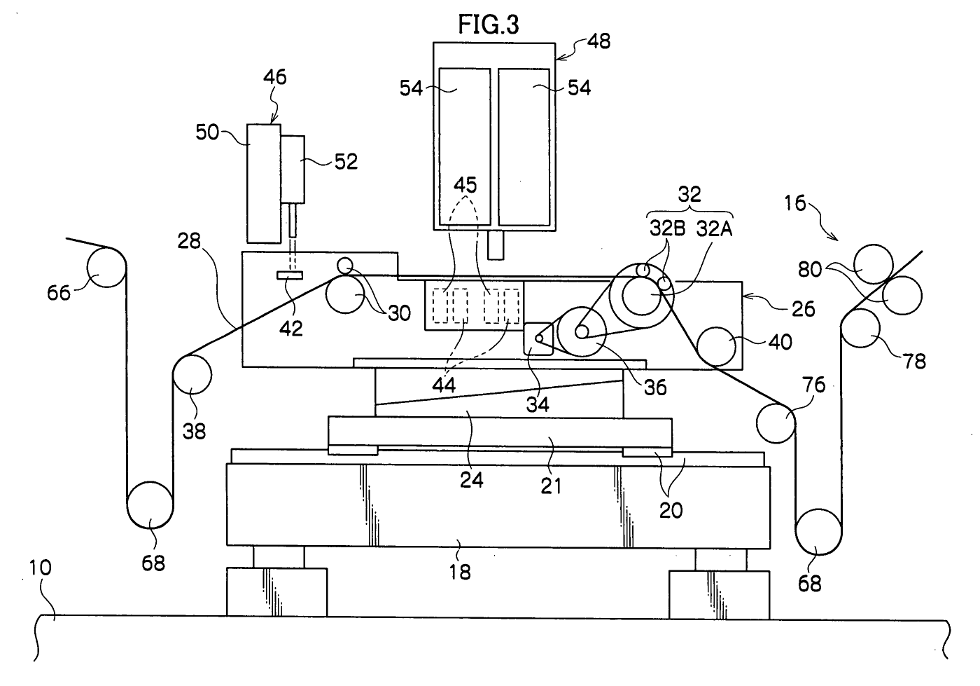

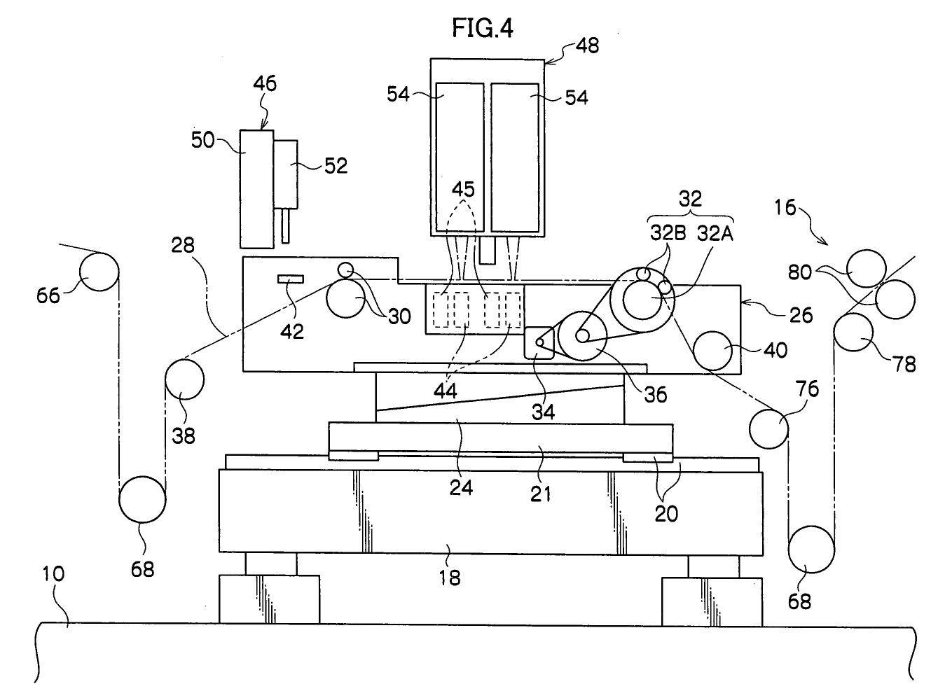

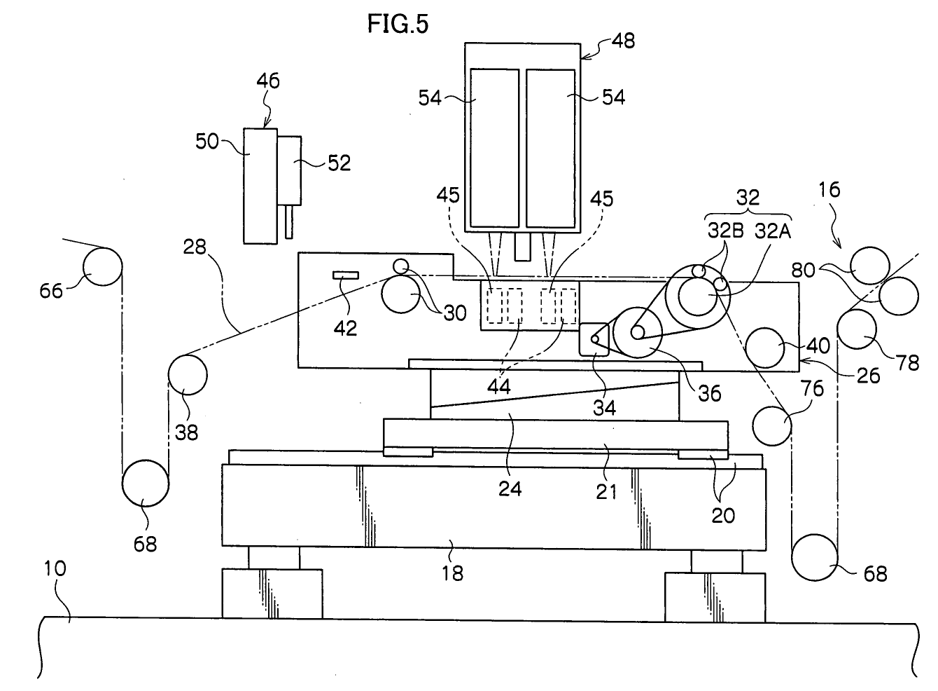

The linear moving mechanism 20 is capable of moving the entire board carrying portion 22 from the exposure processing position shown in FIGS. 1 and 2 to an alignment camera calibration position shown in FIG. 3, a beam position detection position shown in FIG. 4, and an exposure power calibration position shown in FIG. 5.

As shown in FIGS. 1 and 2, in the board carrying portion 22, a board thickness adjustment Z stage 24 is mounted on the carrying table 21, and a scanning carrying portion 26 having a detection unit is provided on this board thickness adjustment Z stage 24.

In the board thickness adjustment Z stage 24, the height of the entire scanning carrying portion 26 having the detection unit can be moved in parallel in the height direction (Z-axis direction) by means of a fine adjustment mechanism using a slope for adjustment of the height position of the recording medium exposure face.

In the scanning carrying portion 26 having the detection unit, as shown in FIG. 2, a pair of nip rollers 30 are disposed upstream along the carrying direction and a pair of nip drive rollers 32 are disposed downstream along the carrying direction in order to carry a flexible printed wiring board material 28, which is a long flexible recording medium. This nip drive roller pair 32 comprises a drive roller 32A and plural (2 in this example) nip rollers 32B rolling on the outside peripheral face thereof. The flexible printed wiring board material 28 is nipped between the drive roller 32A and the nip roller 32B, so that when the drive roller 32A rotates, the flexible printed wiring board material 28 is carried without generation of slippage.

A rotation drive force of a predetermined rotation rate, which is outputted by a drive motor 34 and decelerated by a deceleration mechanism 36, is transmitted to the drive roller 32A. As a consequence, the nip drive roller pair 32 carries the flexible printed wiring board material 28 at a predetermined scanning speed.

The nip roller pair 30 disposed at the scanning carrying portion 26 having the detection unit is constituted by two nip rollers such that they are kept in a rolling contact, and the flexible printed wiring board material 28 is nipped and held between the nip rollers of the nip roller pair 30. When the pair of the nip rollers 30 rotate, the flexible printed wiring board material 28 is fed out.

On the carrying path of the scanning carrying portion 26 having the detection unit, a guide roller 38 is disposed upstream from the pair of nip rollers 30, and a guide roller 40 is disposed downstream from the pair of nip drive rollers 32.

In the scanning carrying portion 26 having the detection unit, as shown in FIG. 2, a calibration scale 42 is disposed at a predetermined position on an extended line at an upstream side in the carrying direction with respect to an exposure carrying path for the flexible printed wiring board material 28.

Further, within the scanning carrying portion 26 having the detection unit, a beam position detecting unit 44 and an exposure surface power measuring unit 45 are disposed at a predetermined position between the pair of nip rollers 30 and the pair of nip drive rollers 32 such that they are adjacent to each other just below the carrying path.

As shown in FIGS. 1 and 2, an alignment unit 46 is disposed at an upstream side in the carrying direction above the board carrying portion 22 in the exposure processing portion 12, and an exposure head unit 48 is disposed as an image-forming unit at a downstream side in the carrying direction.

This alignment unit 46 is provided on a base portion 50 attached to a fixed structure (not shown) of a case or the like of the image-forming apparatus. A pair of rail portions (not shown), which are parallel to each other, are provided on this base portion 50, and plural (4 in this embodiment) camera portions 52 are mounted movably so as to align the optical axis of a lens portion with a desired position in the width direction of the flexible printed wiring board material 28 via a camera base moved by a ball screw mechanism.

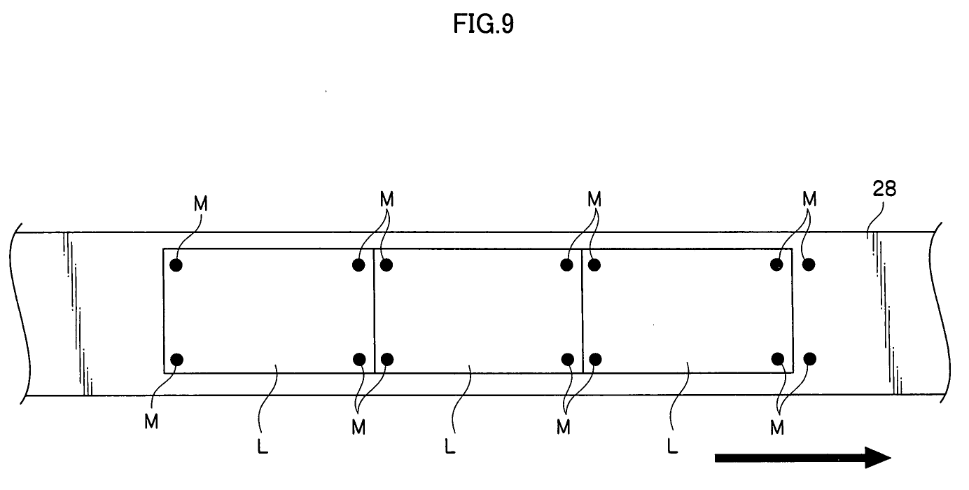

A lens portion (not shown) is provided on the bottom face of each camera portion 52, and a ring-like strobe light source (for example, an LED strobe light source) is mounted at a projecting front end portion of the lens portion. Then, this camera portion 52 irradiates light from the strobe light source to the flexible printed wiring board material 28, and its reflection light is picked up by the camera main body through the lens portion, in order to detect an end portion or a mark M (shown in FIG. 9) of the flexible printed wiring board material 28.

As shown in FIGS. 1 and 2, an exposure head unit 48 as an image-forming unit disposed in the exposure processing portion 12 is mounted on supports (not shown) erected outside both ends in the width direction of the carried flexible printed wiring board material 28.

The exposure head unit 48 of this image-forming unit is constructed as a laser exposure unit, in which plural head assemblies 54 are disposed substantially in a matrix configuration of m rows×n columns (two rows by four columns, totaling eight in this embodiment) and such that the rows of the plural head assemblies 54 are arranged along the width direction of the flexible printed wiring board material 28 (a direction perpendicular to the carrying direction, corresponding to a direction perpendicular to the scanning direction which is the carrying direction of the flexible printed wiring board material 28).

As shown in FIG. 1, a light source unit 56 is provided inside this image-forming apparatus main body. This light source unit 56 accommodates plural laser (semiconductor laser) light sources and a light beam emitted from each of the laser light sources is introduced into each corresponding head assembly 54.

Each head assembly 54 modulates the introduced light beam by means of a digital micro mirror device (DMD) (not shown), which is a spatial optical modulating device, and focuses the light beam on the flexible printed wiring board material 28 by an auto focusing mechanism to irradiate the flexible printed wiring board material 28 with a two-dimensional pattern.

The digital micro mirror device (DMD) of each head assembly 54 is controlled in units of one dot by the image processing portion of the control unit 58 based on an image pattern so as to expose the flexible printed wiring board material 28 to a dot pattern.

In the exposure head unit 48 as an image-forming unit, the flexible printed wiring board material 28 is carried at a constant speed, and plural light beams are projected from each head assembly 54 at a predetermined timing to the flexible printed wiring board material 28 in order to carry out exposure processing. Because each head assembly 54 executes light exposure after focusing by the auto focus mechanism, even if there is some variation in the height position of the flexible printed wiring board material 28, appropriate exposure processing can be performed.

In this exposure head unit 48, although not shown, the exposure area by a single head assembly 54 is configured sp as to be a rectangle inclined at a predetermined angle with respect to the scanning direction while its scanning direction is a short side. A belt-like exposed area of each head assembly is formed on the flexible printed wiring board material 28 carried in the scanning direction.

Because this exposure head unit 48 executes light exposure with the exposure area inclined at a predetermined angle with respect to the scanning direction, the dot pattern of a two-dimensional arrangement to be exposed to light is inclined with respect to the scanning direction. As a consequence, respective dots arranged in the scanning direction pass between dots arranged in a direction perpendicular to the scanning direction so that a pitch between dots is substantially narrowed, thereby achieving a high resolution.

In this image-forming apparatus, when a relative variation in position between the flexible printed wiring board material 28 being carried and the exposure head unit 48, the camera portion 52 photographs a mark M or the like provided on the flexible printed wiring board material 28 to detect the amount of variation between the flexible printed wiring board material 28 and the exposure head unit 48. Then, by correcting the exposure processing by the exposure head unit 48, appropriate exposure processing can be executed with respect to the flexible printed wiring board material 28.

In order to carry out exposure processing continuously on the flexible printed wiring board material 28, which is carried on the carrying path set in the exposure processing portion 12, as shown in FIGS. 1 and 2, this exposure apparatus is provided with a recording medium supply portion 14 for supplying an unexposed recording medium, connected to the upstream side of the carrying path of the exposure processing portion 12 and a recording medium collecting portion 16 for collecting an exposed recording medium, connected to the downstream side of the carrying path of the exposure processing portion 12.

This recording medium supply portion 14 comprises a supply reel 60 on which an unexposed, long flexible printed wiring board material 28 is wound, a spacer winding reel 62 and a drive unit 64.

In this unexposed recording medium supply portion 14, the flexible printed wiring board material 28 pulled out from the supply reel 60 is carried to an intake of the recording medium carrying path of the exposure processing portion 12 through a dancer roller mechanism as a tension setting means.

In the meantime, although not shown, it is preferable to dispose a first dancer roller mechanism between the supply reel 60 and the intake of the recording medium carrying path of the exposure processing portion 12 and to dispose a second dancer roller mechanism through a clean roller.

In this dancer roller mechanism, a dancer roller 68 is disposed rotatably at a portion in which the flexible printed wiring board material 28 is slacked into a U shape between the outlet side roller 66 of the recording medium supply portion 14 for supplying the unexposed recording medium and the intake guide roller 38 in the exposure processing portion 12. This dancer roller mechanism can be substituted by a so-called air dancer which sucks the flexible printed wiring board material 28 with air.

In the recording medium supply portion 14 having such a structure, the supply reel 60 is rotated by the drive unit 64 so that the flexible printed wiring board material 28 is supplied continuously to the carrying path of the exposure processing portion 12 through the pull-out dancer roller mechanism.

The flexible printed wiring board material 28 is wound around this supply reel 60 with spacer tape 61 interposed therebetween so as to prevent the flexible printed wiring board materials 28 from making direct contact with itself. Thus, in the unexposed recording medium supply portion 14, a spacer tape winding reel 62 is driven by a drive unit 64 to wind up the spacer tape 61 extended together with the carried flexible printed wiring board material 28 on the spacer tape winding reel 62.

The exposed recording medium collecting portion 16 for collecting the exposed recording medium comprises a winding reel 70 for winding up the exposed long flexible printed wiring board material 28 and a spacer tape supply reel 72, which is mounted on a drive unit 74.

In this exposed recording medium collecting portion 16, the exposed flexible printed wiring board material 28 carried from the exposure processing portion 12 is wound around the winding reel 70 through the dancer roller mechanism as the tension setting means, which is connected to the outlet of the recording medium carrying path of the exposure processing portion 12.

In this dancer roller mechanism, a dancer roller 68 is disposed rotatably at a portion in which the flexible wiring board material 28 is slacked in a U shape, between a holding roller 76 disposed at a downstream side in the carrying direction with respect to the outlet guide roller 40 of the exposure processing portion 12 and the intake roller 78 for the exposed recording medium collecting portion 16.

In this exposed recording medium collecting portion 16, a pair of nip rollers 80 are disposed between the intake roller 78 and the winding reel 70, and tension created when the winding reel 70 pulls the exposed flexible printed wiring board material 28 is absorbed by the pair of the nip rollers 80 to prevent tension from being transmitted to the dancer mechanism disposed at an upstream side of the exposed recording medium collecting portion 16 on the carrying path.

In the exposed recording medium collecting portion 16 having such a structure, the drive unit 74 rotates the winding reel 70 to wind up and collect the flexible printed wiring board material 28 fed out from the exposure processing portion 12 through the dancer roller mechanism.

Further, when the flexible printed wiring board material 28 is wound up around the winding reel 70 in the exposed recording medium collecting portion 16, the spacer tape 61 is interposed between winding faces thereof to prevent the flexible printed wiring board material 28 from making direct contact with itself Thus, in the exposed recording medium collecting portion 16, the spacer tape supply reel 72 is rotated by the drive unit 74 for pulling out the spacer tape 61 from the spacer tape supply reel 72 for the spacer tape 61 to be wound up together with the carried flexible printed wiring board material 28.

In the image-forming apparatus having the above-described structure, as shown in FIGS. 1 and 2, an exposure carrying path of the exposure processing portion 12 is provided between the dancer roller mechanism of the unexposed recording medium supplying portion 14 and the dancer roller mechanism of the exposed recording medium collecting portion 16.

In the exposure carrying path of the exposure processing portion 12, while the flexible printed wiring board material 28 stretched between the nip roller pair 30 and the nip drive roller pair 32 is carried in a main running direction (main scanning direction) at a predetermined speed by driving the nip drive roller pair 32 by means of the drive motor 34, exposure processing is carried out by the exposure head unit 48.

When the exposure processing is executed by the exposure processing portion 12, the same tension is applied to the flexible printed wiring board material 28 stretched on the exposure carrying path both at a position below and corresponding to the alignment unit 46 and a position below and corresponding to the exposure head unit 48. At the same time, the tension acting on the flexible printed wiring board material 28 stretched on the exposure carrying path of the exposure processing portion 12 is kept at a predetermined tension by both of the dancer roller mechanism disposed at the upstream side in the carrying direction and the dancer roller mechanism disposed at the downstream side in the carrying direction.

Thus, this exposure processing portion 12 is capable of executing appropriate exposure processing in a two-dimensional pattern on the surface of the flexible printed wiring board material 28 stretched horizontally with a predetermined tension kept constant by the respective head assemblies 54 in the exposure head unit 48.

Further, because the exposure processing portion 12 is capable of continuously executing exposure processing on the flexible printed wiring board material 28 carried at a constant speed in the main running direction, an operation of reciprocating the flexible printed wiring board material 28 just below the exposure head unit 48 can be eliminated so that the exposure processing is executed rationally thereby improving working efficiency.

In this image-forming apparatus, based on position data of the mark M or end portion obtained when the alignment unit 46 photographs the flexible printed wiring board material 28, the control unit 58 obtains a correction coefficient relating to an exposure start-up position of the exposure processing by the exposure head unit 48 and a shift position of dot in the width direction of the flexible printed wiring board material 28. Then, the control unit 58 controls the exposure processing by correcting the two-dimensional pattern by each head assembly 54 in the exposure head unit 48, image recording start-up timing and the like, based on these correction coefficients, in order to correct the position of an image to be projected on the flexible printed wiring board material 28 to an appropriate position.

Because, in the exposure processing portion 12 of this image-forming apparatus, the same tension is applied to both of a portion of a detection object on the flexible printed wiring board material 28 just below the alignment unit 46 and a portion of a detection object on the flexible printed wiring board material 28 just below the exposure head unit 48, and the flexible printed wiring board material 28 is carried at the same speed in the main running direction (main scanning direction), a detection result of the alignment unit 46 can be applied to the exposure head unit 48 without any error, thereby improving the precision of the exposure processing.

Next, the calibration means of the alignment unit 46 for use in this image-forming apparatus will be described. In this image-forming apparatus, alignment for adjusting a relative positional relation between the flexible printed wiring board material 28 and the exposure head unit 48 is executed.

In the alignment of this image-forming apparatus, when size data of the flexible printed wiring board material 28 is inputted by an input portion (not shown), the position of the camera portion 52 of the alignment unit 46 is adjusted in the width direction of the flexible printed wiring board material 28 based on the inputted size data.

Further, in this image-forming apparatus, a predetermined range in the length direction of the flexible printed wiring board material 28 being carried in the main scanning direction is photographed by each camera portion 52 to detect the mark M formed on the flexible printed wiring board material 28 for detection of an exposure position, and by comparing with a reference position of each camera portion 52, exposure correction data is generated. Using a pulse counter or the like (not shown) based on this correction data, exposure processing is carried out with a timing for the exposure start-up position of the flexible printed wiring board material 28 to reach an exposure beam irradiation position of the exposure head unit 48.

In this image-forming apparatus, the position of the alignment camera portion 52 is calibrated to achieve appropriate alignment. The calibration of the position of this alignment camera portion 52 is carried out with a calibration scale 42.

Thus, in this image-forming apparatus, the linear moving mechanism 20 is driven to move the entire board carrying portion 22 (scanning carrying portion 26 provided with moving table 21, board thickness adjustment Z stage 24, nip roller pair 30 and nip roller driver roller pair 32 and equipped with the calibration scale 42) from an exposure standby position shown in FIG. 2 in the rightward direction with respect to this drawing and to set the board carrying portion 22 at a position for the alignment camera calibration shown in FIG. 3.

At the position of the alignment camera calibration shown in FIG. 3, each camera portion 52 opposes the calibration scale 42. Based on width position information of a specified alignment mark M, each camera portion 52 for alignment is moved in the width direction of the board.

Because this image-forming apparatus is so constructed that the calibration scale 42 is disposed near the camera portion 52 on the carrying path of the flexible printed wiring board material 28, the position of the alignment camera portion 52 can be calibrated with the flexible printed wiring board material 28 placed on the carrying path of the scanning carrying portion 26 having the detection unit.

In this image-forming apparatus, the calibration scale 42 is photographed with the alignment camera portion 52, and the positional relation between the camera portion 52 and the calibration scale 42 is calibrated from a position at which the pattern of the calibration scale is photographed.

In this image-forming apparatus, after the alignment camera calibration operation is completed, by driving the linear moving mechanism 20, the board carrying portion 22 is restored from the position of the alignment camera calibration shown in FIG. 3 to the exposure standby position shown in FIG. 2.

Next, the calibration means for an exposure position of each head assembly 54 for use in the image-forming apparatus and power distribution within the exposure range will be described.

With no flexible printed wiring board material 28 carried onto the carrying path of the scanning carrying portion 26 having the detection unit, the beam position of each head assembly 54 and the power distribution within the exposure range are measured.

The scanning carrying portion 26 having the detection unit is moved in the rightward direction with respect to this drawing from the exposure standby position shown in FIG. 2 up to the beam position detecting position shown in FIG. 4 in which each head assembly 54 and corresponding beam position detecting unit 44 oppose each other in order to measure the beam position of each head assembly 54. Then, the beam position of each head assembly 54 is measured, and the exposure position of each head assembly 54 is calibrated.

Next, the scanning carrying portion 26 is moved in the rightward direction with respect to the drawing from the beam position detection position shown in FIG. 4 up to the exposure face power calibration position at which each head assembly 54 and corresponding exposure face power measuring unit 45 oppose each other in order to measure power distribution in the exposure range of each head assembly.

At this time, the exposure face power measuring unit 45 is raised only by a predetermined height by driving the board thickness adjustment Z stage 24 in order to match the detection surface of the exposure face power measuring unit 45 with the surface of the carrying path of the flexible printed wiring board material 28.

The power distribution within the exposure range of each head assembly 54 is measured with the corresponding exposure face power measuring unit 45 and the power within the exposure range is calibrated so as to enable an appropriate two-dimensional pattern to be formed.

After the operation of calibrating the exposure position of each head assembly 54 and the operation of calibrating power in the entire exposure range is completed, the entire board carrying portion 22 is restored from the exposure face power calibration position shown in FIG. 5 up to the exposure standby position shown in FIG. 2 by driving the linear moving mechanism 20.

Next, the operation and action of the image-forming apparatus having the above described structure will be described.

Before the exposure processing is started, calibrations of the alignment camera portion 52, the exposure position with respect to each head assembly and power distribution within the exposure range are carried out. The calibration of the alignment camera portion 52 can be carried out as required.

Next, the flexible printed wiring board material 28 which is the object of the exposure processing is set on the carrying path from the unexposed recording medium supplying portion 14 up to the exposed recording medium collecting portion 16 through the exposure processing portion 12. Thus, the flexible printed wiring board material 28 is pulled out from the supply reel 60 and passed through the carrying path of the exposure processing portion 12, and then its front end is fixed on the winding reel 70.

After that, the supply reel 60 is rotated until slack of the flexible printed wiring board material set on the carrying path, in a state of greatest slack, reaches a predetermined amount (maximum limit of the slack) between the outlet side roller 66 on the side of the supply reel 60 and the intake guide roller 38 on the side of the exposure processing portion 12, and the dancer roller 68 is set on that slack portion. After that, when it is detected that the slack reaches its minimum limit (state of least slack), the supply reel 60 is rotated until it is detected that the slack has reached its maximum limit.

Next, the nip drive roller pair 32 is rotated until the slack of the flexible printed wiring board material 28, in a state of least slack, reaches its predetermined amount (minimum limit of the slack) between the carrying path outlet side holding roller 76 of the exposure processing portion 12 and the intake side roller 78 of the exposed recording medium collecting portion 16, and the dancer roller 68 is set on the slack portion. After that, when it is detected that the slack has reached its maximum limit (state of greatest slack), the winding reel 70 is rotated until it is detected that the slack has reached its minimum limit.

While the flexible printed wiring board material 28 is fed by driving the nip drive roller pair 32, the surface of the flexible printed wiring board material 28 is photographed with the alignment camera portion 52 at a predetermined interval, and when the mark M of the exposure start position provided on the flexible printed wiring board material 28 is photographed (detected), the nip drive roller pair 32 is stopped to attain a standby condition.

When the flexible printed wiring board material 28 is fed by a predetermined amount by rotating the nip drive roller pair 32, the alignment mark M in the unit exposure region L provided on the flexible printed wiring board material 28 at a preceding step is photographed by the alignment camera portion 52 to measure the position of the mark M in the unit exposure region L. In the meantime, measurement of the mark M in the unit exposure region L is preferably carried out at two or more positions in the unit exposure region L (at four or more positions around the unit exposure region L) in the feeding direction of the flexible printed wiring board material 28. However, if the board is not expanded or deformed, it is possible to do so at two positions (up and down or right and left in the unit exposure region L).

When the measurement of the position of the mark M in the unit exposure region L is completed, the control unit 58 executes deformation processing of exposure data according to measured values of the position of the mark M in the unit exposure region L so that a projected image corresponds to an expanded or deformed condition. In the meantime, at this time, the control unit 58 may execute a processing including image recording position correction (exposure start-up timing correction).

The control unit 58 performs control to feed the flexible printed wiring board material 28 continuously while the deformation processing of the exposure data is carried out, and the positioning of the alignment mark M in a next unit exposure region L is carried out.

Next, the control unit 58 completes the deformation processing of exposure data, and when the front of the unit exposure region L is fed to the position of the exposure head unit 48, exposure on the flexible printed wiring board material 28 is started by each head assembly 54. When the rear end of this unit exposure region L passes the exposure head unit 48 and reaches a predetermined position, the exposure on the unit exposure region L is stopped.

This exposure processing is carried out when the unit exposure region L of the flexible printed wiring board material 28 passes the exposure region of the exposure head unit 48. In this exposure processing, each head assembly 54 projects a laser beam to a DMD based on exposure data deformed by the control unit 58, and a laser beam, which is reflected when the micro mirror of this DMD is turned on, passes through an optical path set by the optical system and is focused on the flexible printed wiring board material 28.

The above-mentioned exposure processing is carried out continuously, and when the light beam has been projected to the unit exposure region L a specified number of times, the nip drive roller pair 32 is stopped and the exposure processing is completed.

In this image-forming apparatus, with the flexible printed wiring board material 28 stretched between the nip roller pair 30 and the nip drive roller pair 32, the nip drive roller pair 32 is rotated at a constant speed to feed the flexible printed wiring board material 28 continuously. Then, a laser beam is projected continuously by the head assembly 54 to a stretched portion of the flexible printed wiring board material 28 between the nip roller pair 30 and the nip drive roller pair 32 to form an image. Because this image-forming apparatus is capable of always executing the exposure processing continuously as compared with a type, in which a processing for alignment adjustment is executed on a recording medium on one movement and the exposure processing is executed on a return movement, productivity can be improved.

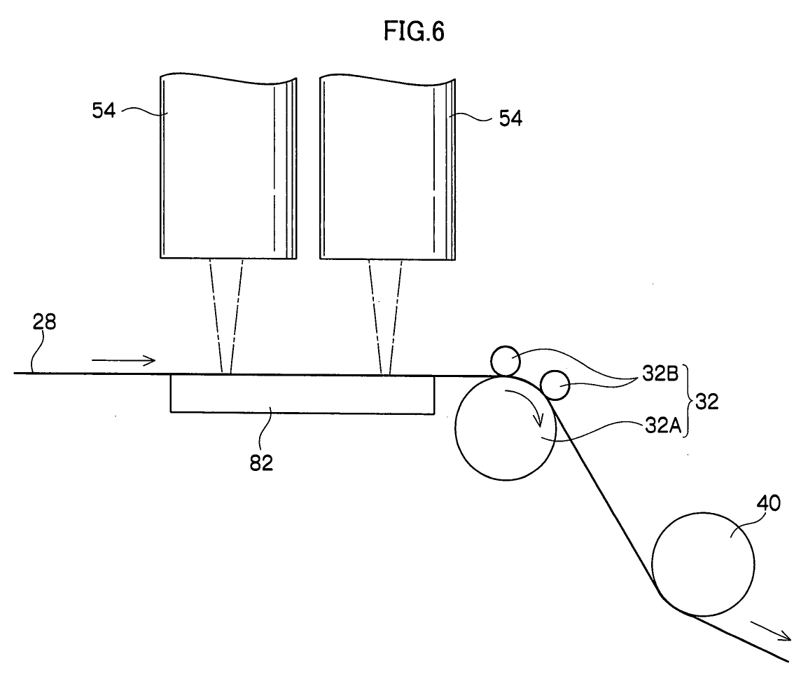

Next, an example of a structure in which a guide for the flexible printed wiring board material 28 is provided on the carrying path of the exposure processing portion 12 in the above image-forming apparatus will be described with reference to FIG. 6.

In the exposure processing portion 12 shown in FIG. 6, a flat sliding guide member 82 is disposed as a lower supporting means at a position just below the flexible printed wiring board material 28 corresponding to the entire exposure processing region by the head assembly 54 on the carrying path.

A guide plane, which makes sliding contact with the flexible printed wiring board material 28 to support it from below for guiding, is provided on the flat sliding guide member 82.

Due to the provision of the flat sliding guide member 82, the flexible printed wiring board material 28 being carried on the carrying path is guided to slide on the guide plane of the flat sliding guide member 82 to keep a flat condition and undergo the exposure processing by each head assembly 54. With such a structure, upon the exposure processing, its flatness can be kept at a higher precision. Thus, the flat plane of the flexible printed wiring board material 28 is prevented from being deflected by disturbance to achieve more stabilized exposure processing.

Instead of the flat sliding guide member 82 as this lower supporting means, it is permissible to provide a single or plural guide rollers in rolling contact with each other at a position just below the camera portion 52 and at a position just below the exposure head unit 48 (not shown) to carry the flexible printed wiring board material 28 while guided in a flat condition.

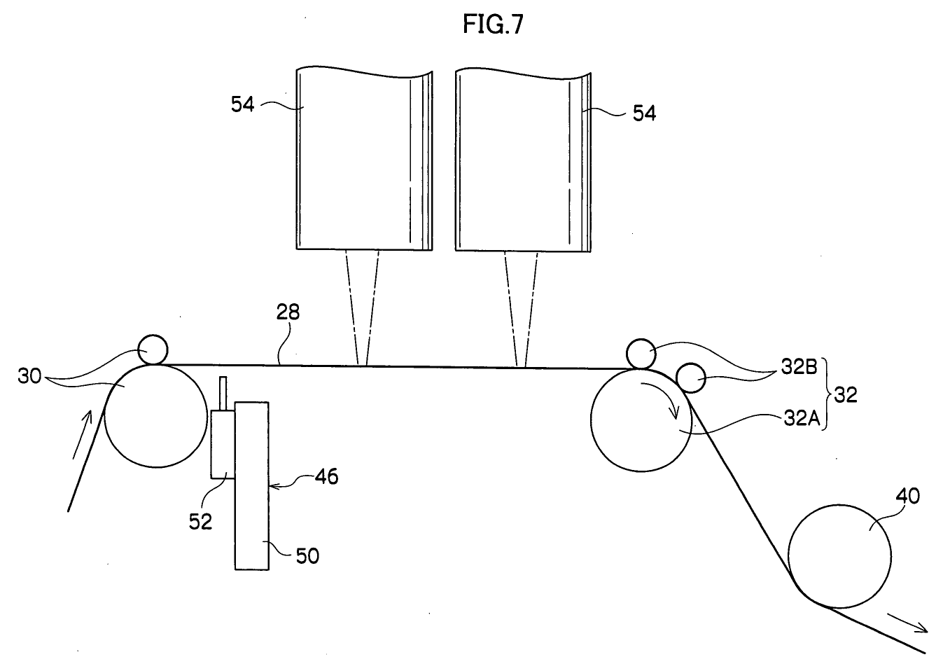

An example in which the alignment unit 46 is disposed below the carrying path of the exposure processing portion 12 (opposite side to the head assembly 54 of the exposure head unit 48) in the image-forming apparatus shown in FIGS. 1 to 5 will be described with reference to FIG. 7.

In the exposure processing portion 12 shown in FIG. 7, the alignment unit 46 is disposed below the carrying path of the exposure processing portion 12. The alignment mark M is formed on the rear face opposite to a surface to be exposed to light of the flexible printed wiring board material 28.

Because, in the exposure processing portion 12 shown in FIG. 7, there is no structure to be disposed below the carrying path, freedom of the layout of the exposure position can be expanded.

In the image-forming apparatus having such a structure, the alignment mark M formed on the rear face of the flexible printed wiring board material 28 is detected by the alignment unit 46 disposed below the carrying path to align the flexible printed wiring board material 28 for exposure processing.

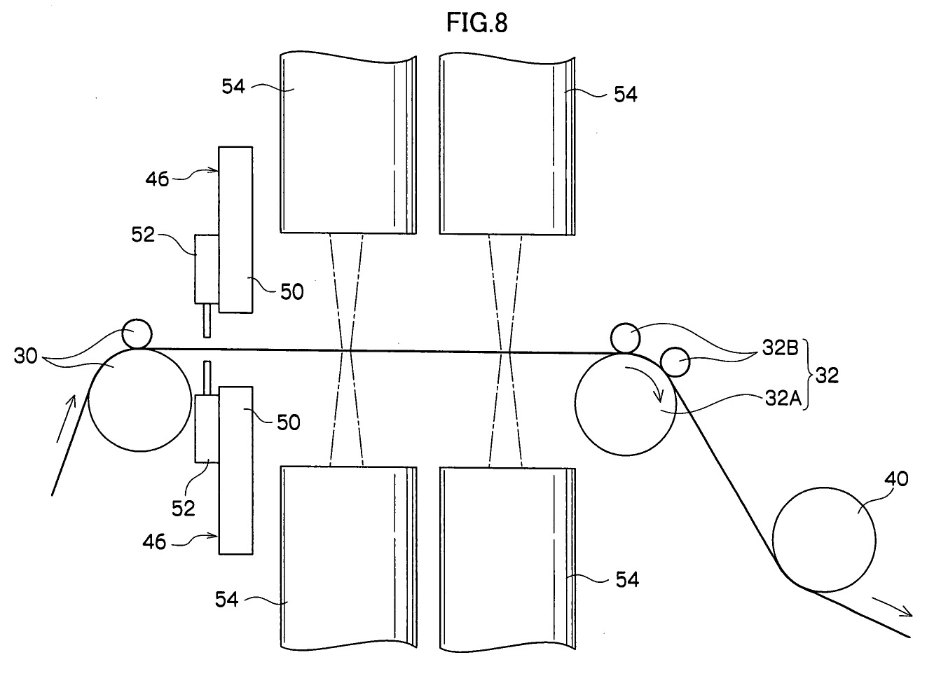

Next, in addition to the image-forming apparatus shown in FIGS. 1 to 5, an example, in which the alignment unit 46 and the head assembly 54 of the exposure head unit 48 are also disposed below the carrying path of the exposure processing portion 12, will be described with reference to FIG. 8.

According to the configuration example shown in FIG. 8, the alignment unit 46 and the head assembly 54 of the exposure head unit 48 are disposed above and below the carrying path in the exposure processing portion 12.

With such a structure, different images can be projected on front and rear surfaces of the flexible printed wiring board material 28 at the same time by a single scanning action by the alignment unit 46 and the head assembly 54 of the exposure head unit 48 disposed on the front surface side and rear surface side of the flexible printed wiring board material 28.

When executing the exposure processing on both the front and rear surfaces of the flexible printed wiring board material 28 at the same time by means of the image-forming apparatus shown in FIG. 8, the efficiency of the exposure processing can be doubled to increase productivity.

Although, according to this embodiment, the DMD is used as a spatial modulation device used in the head assembly 54 of the exposure head unit 48 constructed as a laser exposure unit to generate a dot pattern by turning on and off with a constant lighting time, it is permissible to execute pulse width modulation by ON time ratio (duty) control. Further, it is permissible to set a single lighting time very short and generate the dot pattern depending on the number of lightings.

For this embodiment, the head assembly 54 having the DMD as a spatial optical modulation device has been described above, and in addition to such a reflection type spatial optical modulation device, other spatial optical modulation devices than the MEMS type, for example, a micro electro mechanical systems (MEMS) type special light modulator (SLM), a transmission type spatial optical modulation device (LCD), an optical device (PLZT device) for modulating transmitted light by electric optical effect, or a liquid crystal shutter array of liquid crystal optical shutters (FLC) can be used instead of the DMD. Further, it is permissible to use plural grating light valves (GLV) arranged in a two-dimensional configuration. In the configuration using the reflection type spatial optical modulation device (GLV) and the transmission type spatial optical modulation device (LCD), it is permissible to use lamps as light source as well as the aforementioned laser.

As a light source of this embodiment, it is possible to use a fiber array light source provided with plural synthesized laser beam sources, a fiber array beam source which is arrayed fiber beam sources each provided with a single optical fiber for emitting a laser beam entered from a single semiconductor laser containing a light emitting point, a light source in which plural light emitting points are arrayed two-dimensionally (for example, LD array, organic EL array and the like) and the like.

In this image-forming apparatus, each of photon mode light sensitive material, in which information is recorded directly by exposure to light, and heat mode light sensitive material, in which information is recorded by heat generated by exposure to light, can be used. If the photon mode light sensitive material is used, a GaN series semiconductor laser, a wavelength conversion solid laser or the like is used as a laser unit, and if the heat mode light sensitive material is used, an AlGaAs series semiconductor laser (infrared ray laser) or a solid laser is used as a laser unit.

Although, according to the above-described embodiment, the flexible printed wiring board material 28 stretched between the nip roller pair 30 and the nip drive roller pair 32 is tensed with a constant tension by the dancer roller mechanism as a tension setting means disposed at an upstream side of the nip roller pair 30 in the carrying direction and the dancer roller mechanism as a tension setting means disposed at a downstream side of the nip drive roller pair 32 in the carrying direction, it is permissible to construct a tension setting means which applies a constant tension by rotating one nip roller pair and the other nip roller pair at different speeds or by braking one nip roller pair at a predetermined braking force while carrying the flexible printed wiring board material 28 with the other roller pair.

Meanwhile, the image-forming apparatus of the invention may be constructed as a unit for forming an image on a display board as well as a unit for forming an image on the flexible printed wiring board material 28 as a long belt-like flexible recording medium.

Further, the image-forming apparatus of the invention may be constructed as an image-forming unit which is mounted with an inkjet head instead of an exposure head unit and ejects ink droplets from the inkjet head onto a sheet or the like serving as the long belt-like flexible recording medium to perform image formation by using ink.

The present invention is not restricted to these example. Needless to say, it may be formed in various configurations within a scope that does not depart from the gist of the invention.

What is claimed is:

1. An image-forming apparatus for forming an image on a long flexible recording medium, comprising:
at least two rollers over which the long flexible recording medium is stretched;
a tension setting portion for stretching the long flexible recording medium horizontally by keeping the tension of a portion extending between the two adjacent rollers constant; and
an image-forming unit for forming a two-dimensional pattern on the long flexible recording medium stretched between the two adjacent rollers horizontally.

2. The image-forming apparatus of claim 1, wherein a lower supporting portion for maintaining the flatness of the flexible recording medium is disposed at the back side of the long flexible recording medium stretched horizontally between the two adjacent rollers to form an image with the image-forming unit.

3. The image-forming apparatus of claim 2, wherein the lower supporting portion is a flat sliding guide member.

4. The image-forming apparatus of claim 1, further comprising an alignment unit, the alignment unit being provided on the side of a surface, on which the image is formed, or a surface, on which the image is not formed, of the flexible recording medium at a position at an upstream side of the image-forming unit in the transportation direction with respect to the long flexible recording medium stretched horizontally between the two adjacent rollers.

5. The image-forming apparatus of claim 2, further comprising an alignment unit, the alignment unit being provided on the side of a surface, on which the image is formed, or a surface, on which the image is not formed, of the flexible recording medium at a position at an upstream side of the image-forming unit in the transportation direction with respect to the long flexible recording medium stretched horizontally between the two adjacent rollers.

6. The image-forming apparatus of claim 3, further comprising an alignment unit, the alignment unit being provided on the side of a surface, on which the image is formed, or a surface, on which the image is not formed, of the flexible recording medium at a position at an upstream side of the image-forming unit in the transportation direction with respect to the long flexible recording medium stretched horizontally between the two adjacent rollers.

7. The image-forming apparatus of claim 1, comprising plural image-forming units, the image-forming units being provided on both surface sides of the long flexible recording medium stretched horizontally between the two adjacent rollers.

8. The image-forming apparatus of claim 2, comprising plural image-forming units, the image-forming units being provided on both surface sides of the long flexible recording medium stretched horizontally between the two adjacent rollers.

9. The image-forming apparatus of claim 3, comprising plural image-forming units, the image-forming units being provided on both surface sides of the long flexible recording medium stretched horizontally between the two adjacent rollers.

10. The image-forming apparatus of claim 7, further comprising an alignment unit, the alignment unit being provided at the upstream side of at least one of the image-forming units provided on both surface sides of the long flexible recording medium stretched horizontally between the two adjacent rollers.

11. The image-forming apparatus of claim 8, further comprising an alignment unit, the alignment unit being provided at the upstream side of at least one of the image-forming units provided on both surface sides of the long flexible recording medium stretched horizontally between the two adjacent rollers.

12. The image-forming apparatus of claim 9, further comprising an alignment unit, the alignment unit being provided at the upstream side of at least one of the image-forming units provided on both surface sides of the long flexible recording medium stretched horizontally between the two adjacent rollers.

13. The image-forming apparatus of claim 7, further comprising plural alignment units, the alignment units being provided at the upstream side of the image-forming units provided on both surface sides of the long flexible recording medium stretched horizontally between the two adjacent rollers.

14. The image-forming apparatus of claim 8, further comprising plural alignment units, the alignment units being provided at the upstream side of the image-forming units provided on both surface sides of the long flexible recording medium stretched horizontally between the two adjacent rollers.

15. The image-forming apparatus of claim 9, further comprising plural alignment units, the alignment units being provided at the upstream side of the image-forming units provided on both surface sides of the long flexible recording medium stretched horizontally between the two adjacent rollers.

16. The image-forming apparatus of claim 1, wherein the image-forming unit comprises a laser exposure device.

17. The image-forming apparatus of claim 1, wherein the image-forming unit modulates a light beam with a spatial optical modulation device to execute exposure processing in a two-dimensional pattern.

18. The image-forming apparatus of claim 1, wherein after the image-forming unit modulates a light beam with a spatial optical modulation device, the beam is focused on the long flexible recording medium by means of an auto focus mechanism to project the two-dimensional pattern.
